(19) United States
(12) Patent Application Publication
(10) Pub. No.: US 2003/0152039 A1
(43) Pub. Date: Aug. 14, 2003

(54) Customer billing in a communications network

(76) Inventor: Timothy Roberts, Thaxted (GB)

Correspondence Address: William M. Lee, Jr., Lee, Mann, Smith,, McWilliams, Sweeney & Ohlson, P.O. Box 2786, Chicago, IL, 60690, US

(21) Appl. No.: 10/185,134

(22) Filed: Jun. 28, 2002

Related U.S. Application Data
(60) Provisional application No. 60/355,221, filed on Feb. 8, 2002.

(51) Int. Cl. H04L 12/28

(52) U.S. Cl. 370/255; 379/114.01

(57) ABSTRACT

In a packet communications network, e.g. a third generation wireless network, combined billing of a user is provided for the delivery of communications services to that user and for the on-line purchase of goods and services by the user via the communications network. A set of rules is provided and a respective billing tariff and account is determined from the rules and each packet address. Credit transfers are made between user accounts and the accounts of goods/services supplies held in a common database.

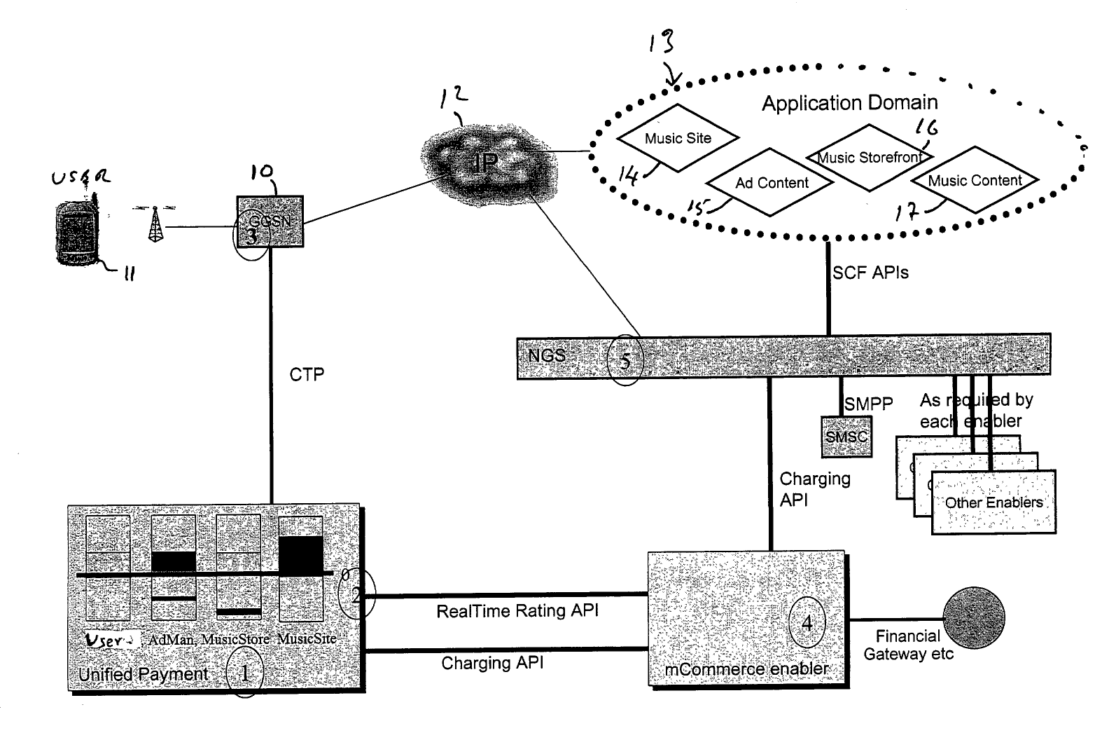

### RELATED APPLICATIONS

This application is the regular filing of provisional patent application No. 60/355,221 filed Feb. 8, 2002 the contents of which are incorporated herein by reference.

### FIELD OF THE INVENTION

This invention relates to systems and methods for billing or tariffing users of a communications network for the use of network resources and services, and for the purchase of goods and services via the network.

### BACKGROUND OF THE INVENTION

In the field of communications, competitive billing or tariffing for use of network resources and services is a key part of attracting and maintaining a strong customer base. With the current migration towards data and multimedia services, billing or tariffing will increasingly become a major factor in encouraging or suppressing the take up and provision of these new technologies and the capabilities they offer. This is a particular problem with the introduction of third generation (3G) wireless networks which are capable of providing the user with a wide variety of services in addition to the conventional voice and text traffic. In addition, in the data world, there are now new opportunities for innovative tariff models based not only on duration or volume of data but also on the value delivered by the data. This value can be independent of volume or duration. For example, a video delivered at voice call bandwidth rates would be far too expensive to be commercially viable and yet a typical text message via SMS (short message service) containing less than a couple of hundred bytes of data, can be charged at a disproportionately high rate. In addition to what is being charged, the data world will also add in new stakeholders in the value chain such as content providers and new business models with the network operator being wholesaler, retailer, credit broker or channel partner as required.

In the Wireless space, the existing billing activities tend to be focussed on charging for data transmission at the granularity of the PDP (Packet Data Protocol) context (i.e the connection of the device to the network). IP services are run over this connection. Since IP is designed to multiplex service delivery, the same PDP context may be used to use multiple services possibly concurrently. The existing billing work in OSA (Open Services Architecture) under CAMEL and IMS does not allow the billing system to differentiate between different services on the same PDP context.

In the IP space, traffic analysis is becoming real, but typical deployments are not centred on data or content based billing since there is not an appropriate charging relationship with the end user. As such, the service provider typically enters into a specific relationship with the end user typically via credit cards. This is limited by the consumers' willingness to provide credit card details, lack of anonymity and the effective disenfranchisement of consumers unable to get credit cards (e.g. those under 18 years of age). Industry initiatives for pay up front and trusted third party payment are beginning to emerge but do not correlate with the data traffic due to a focus on wireline where access charges are either via fixed monthly payment or are quite low.

In the wireless space, access charges are high (e.g. GPRS where each additional Megabyte will cost around $5 under current pricing schemes in comparison to 10-20 cents via local call rate ISP dial-up access). Dial-up is also quicker and more reliable. Wireless access is also error prone and errors result in retransmissions which are also charged—thus the user pays twice (access costs and purchase price) and pays extra when the service is poor.

Correlation in real-time is complex since the billing system cannot have knowledge of all the elements that may be involved in delivery of a particular service, or when complete data on a service interaction will be complete. However, for real-time credit management, the cost of service provision must be applied in a short timescale (minutes) and preferably on-line so that service can be immediately discontinued on expiration of credit.

With the increased value that m-commerce brings, real-time operation is critical for credit risk management.

In addition to the business model changes that are being introduced, there is a need for the infrastructure to support multiple devices, family accounts, mixed business and personal accounts with different billing models for each mix of fixed and wireless access and voice/data, and handle roaming between different networks. Consequently an operator's ability to offer a coherent payment services architecture that enables new services to be quickly launched and rating schemes to be easily modified depending on market conditions, vouchers, discounts, mark-ups, promotions, and so forth will be crucial to that operator's competitive position and future profitability.

Traditionally, postpaid billing has been employed for use of communications resources and services, i.e. the user receives a monthly Or quarterly bill for the services that have been delivered in that period. The success enjoyed by the recently introduced prepaid billing, in which the user purchases credit for future use, is in part due to its ability to handle charging in real time without the need for a downstream billing infrastructure Migration to 3G networks will form an overlay of new services and capabilities that are expected to approach, if not exceed, the capabilities of traditional billing methods. This problem is further exacerbated in networks having a mixture of prepaid and postpaid customers and which thus have an added complexity in the billing procedure

### OBJECT OF THE INVENTION

An object of the invention is to provide an improved billing arrangement and method for a communications network.

### SUMMARY OF THE INVENTION

According to a first aspect of the invention there is provided a method of billing a communications network user for goods or services associated with the transport of packet traffic from that communications network into a packet communications network, each packet having an address, wherein the method comprises; providing a set of rules, and determining from said rules and each packet address, a respective billing tariff and account for that packet.

The billing costs are debited from the relevant customer account. Prepaid customers may have a zero credit limit. Postpaid customers may be accommodated in the system by allowing their accounts to go into debit e.g. to a prearranged limit.

According to another aspect of the invention there is provided apparatus for billing a communications network user for goods or services associated with the transport of packet traffic from that communications network into a packet communications network, the apparatus comprising: means for providing each packet with an address, a store having a set of rules, and a packet analyzer for determining from said rules and each packet address, a respective billing tariff and account for that packet.

According to another aspect of the invention there is provided a method of on-line shopping in which the cost of purchased goods or services are debited to a customer pre-paid or postpaid account and a corresponding credit is applied to an account held by the provider of those goods or services.

The network operator may receive a fixed service fee per transaction or a service fee based on the value of the transaction.

In a preferred embodiment in which the packet communications network comprises a third generation wireless network, combined billing of a user is provided for the delivery of communications services to that user and for the on-line purchase of goods and services by the user via the communications network. A set of rules is provided and a respective billing tariff and account is determined from the rules and each packet address. Credit transfers are made between user accounts and the accounts of goods/services supplies held in a common database.

The method provides billing for such purchases to the purchaser's telephone account and thus enables a purchaser to complete transactions without the need for a credit or debit card. The method also has the advantage that a system user need never disclose his/her credit/debit card details thus reducing the risk of fraudulent transactions.

The methods may be performed by or under the control of software in machine readable form on a storage medium.

The system proposes a way to coordinate billing data in real-time so that the operator can provide for a number of basic billing scenarios which involve correlating standard usage based billing techniques (volume and duration) with e-commerce purchases and event based billing.

The finer grained charging information is achieved via the analysis of packets, preferably at the GGSN. This is coordinated with the service being accessed via configuring rules based on the destination of the service as described by URL or IP address and port number of the server. Further discrimination can be applied via the protocol being used if required. Since this knowledge is provisioned into the system, the specific destination can be used to determine charging without recourse to other systems and hence can be done in real-time. Via split tariffing (rating which applies to more than one account) multiple parties may pay for any given chargeable service and hence a full range of business models can be applied. By performing all charging events in real-time (by extension of the Prepaid model) full credit management facilities may be supported. Use of real-time accounts for suppliers and commercial partners means that credit management can apply to them too and not just for subscribers. Allowing negative balances on prepaid accounts and by issuing monthly bills for payment, existing prepaid systems can support the postpaid users thereby unifying all accounts to a single system.

With this infrastructure in-place, the e-wallet concepts can be applied with the operator managing the wallet to provide a single point of trust and thus eliminate the need for entering credit card details with each purchase. By allowing the telephony account (prepaid or postpaid) to be debited, the operator can offer this form of credit as a payment method to merchant partners. Since prepaid can now be used to pay for m-commerce transactions, the requirement for credit cards is eliminated thereby enabling all subscribers to access this facility.

### BRIEF DESCRIPTION OF THE DRAWINGS

An embodiment of the invention will now be described with reference to the accompanying drawing in which the single FIGURE is a schematic diagram of a tariffing and payment architecture.

### DESCRIPTION OF PREFERRED EMBODIMENT

Referring to the drawing, this shows in schematic form a wireless network, e.g. a 3G network providing user access from a terminal 11 via a gateway serving node (GGSN) 10, an IP network 12 to an application domain 13 from which goods or services may be delivered to the user. The application domain contains a number of servers including, for example, a music site 14, an advertisement content server 15, a music storefront 16 and a music content server 17. Transactions with these different servers will attract different billing rates, including where appropriate a zero rate, to the user and the site owner. Further, the user may be offered credits for some transactions. The transactions can also include the transfer of credit from one account to another, e.g. as part of a transaction for the purchase of goods or services.

As illustrated in the drawing, the functionality of the billing system is split into five main components:

A Unified Account Database (1) supports real-time updates to user balances including the usual reservation model supported by today's prepaid solution. This component (shown as pan of unified payment in the drawing) also provides management and user access to account balance information for customer care functions. This component is capable of being scaled to support all the subscriber base for the operator and, preferably, also an account for each third party partner through which the various business models can be supported. Balances are capable of being positive or negative and have a credit or debit limit (preferably soft and hard) per transaction, per user and per account which is enforced in real-time. Where a credit limit is reached, the account database may initiate credit limit increase request and/or recharge opportunity via credit(debit card. Positive authorization, reservation and confirmation features are provided. The account database has all the attributes of a real time accounting system in terms of its robustness and reliability.

1. Real-time Rating Engine (2) provides the single point for all rating and tariffing data including such capabilites as voucher management and advice of charge. Advantageously, the real time rating engine is incorporated within the unified payment function. This engine also applies various operator level policies such as discounting, mark-up, taxation, etc. Its function is to accept charging events with relevant data (such as time of day, event type, subscriber, merchant, possibly dollar value) and return the value to be charged to the customer along with any details about charges to be applied to other accounts e.g. merchant for revenue share. Note that charges may comprise credits or debits. The real time rating engine may be incorporated in the unified account database.

Real-time in-line packet analyser (3) handles the usage based aspects of the tariff regime. This function appeal to both the previous two components to determine both the price of any particular packets and whether the user has the credit to allow the interaction to proceed and if not to stop the session. As indicated in the drawing, the packet analyser is conveniently incorporated in the GGSN (gateway serving node)). interface into the financial institutions or mcommerce enabler (4) offers credit/debit card capabilities. This function also manages the selection of the payment method Wallet functionality) and hence interfaces to the rating engine (2) to determine the net price to the user for any event and the account database when this is the preferred method of payment. The mcommerce enabler also provides access to financial gateways 19.

OSA Gateway (5) offers the charging capabilities to third parties in a controlled and secure way. The function of this component is to validate third party identities, offer a charging API in a convenient form for the application and to do this in context with access to other operator provided capabilities such as location information, call setup, bulk SMS and so forth. The OSA gateway 5 may also provide access to a short message centre 18

The use of a single centralized database for all accounts both subscriber and commercial partners, simplifies the overall management of the system and integrates revenue sharing with revenue collection into a single repository. This symmetry also allows the operator to apply many of the same credit management functions to commercial partners as to subscribers. This makes it feasible to support more, smaller partners via simpler commercial arrangements, indeed partners could work on a prepaid basis if so required. In the case of revenue sharing, the operator can extract his or her share, plus any additional costs (e.g. charges for account enquiries etc) prior to settlement and maintain a real-time view of their financial status vis-a-vis their partners

The merging of pre and post paid models behind a single system allows subscribers to migrate between these forms conveniently and easily and supports hybrid forms e.g. family accounts giving children credit limits but the parents postpaid, all combined into the same account.

The use of a single rating engine at the operator level enhances the operators' ability to differentiate their offerings through promotions, independently of their commercial partners. At the same time it reduces management complexity by offering a single point of provisioning of tariff data. Rating by the operator in no way precludes rating by the application provider, e.g. for on-line stores, but it does offer a point for promotions, taxation, mark-up, delivery charges etc. and to make the total charge visible to the subscriber prior to confirming the purchase.

The use of wallet functions offers enhanced security and convenience to the user. This enhanced confidence level will help stimulate on-line transaction volumes. This also enhances the operator's value to the third party merchants since it allows those merchants to access more of the credit potential in the operators' subscriber base.

Full support of a pre-paid model allows the operator to build subscriber base of those unwilling or unable to get credit cards (e.g. teenagers) without taking undue credit risks and thus makes e-commerce fully available to that class of customer.

The OSA (open services architecture) gateway model provides a standards compliant way to package up these capabilities and offer the package to third parties without requiring extensive (and expensive) development and test cycles to guarantee network integrity. The OSA model does not just offer access to charging facilities but also delivers other network functions such as location information, call control etc. In addition the OSA gateway can itself apply intelligence to the transaction. For example when a third party application requests location information from the network the OSA gateway can also initiate an associating charging event. This supports both retail and wholesale models.

To simplify content-based billing, content value is differentiated by the location of the content (IP address or URL). This information is pre-provisioned statically as required by the operator. Thus if the operator enters a deal to provide premium rate access charges as a billing mechanism for a site, the operator implements the agreement by provisioning the relevant URLs as required into the GGSN. This is a sufficiently powerful solution to address most such requirements but does not impact network architectures or require an additional component in the network to perform the analysis thus avoiding a significant increment to cost, complexity, latency and resource usage.

The infrastructure also processes transport charges generated by network elements notably volume and duration based billing for voice/data over packet or circuit switched connections. Since this is the operator core business, these charges are always applied directly to the user account and the elements interface directly to the accounts database component which arbitrates the rating aspects in an extension of the current prepaid solutions to all accounts. Use of the common rating engine, support for multiple charges and holding of merchant accounts within the accounts database enables the sharing of charges amongst multiple parties and provides for revenue sharing e.g. 0800, Premium rate type functions.

Two primary call flows are supported corresponding to event charges or duration/volume charges. The flows below are generic and logical communications and need not always all occur.

Generic Event Charge Call Flow

Events of this style are generated by applications. However, these may be generated by the OSA gateway on behalf of the application if required e.g. a location look-up request could always result in a charging request being generated. This would be the normal model for wholesale functions where the application provider is charged for the operation since the operator would wish to generate the charges.

1) Application sends Event Request for Authorisation to OSA Gateway 5.

2) OSA gateway forwards request to mcommerce enabler with any additional data including authenticated application id.

3) Mcommerce enabler invokes Rating which returns price of event (possibly based on historical data etc). Note that the event may already have a price, but this is potentially changed via Rating for taxes, vouchers etc.

4) Mcommerce enabler checks with policy whether authorisation and/or Advice of Charge is required and preferred method of payment (account vs credit/debit cards etc)

5) If Authorisation is required, Mcommerce enabler performs necessary check (against balance or credit limit as appropriate)

6) Mcommerce enabler returns yes or no plus price and AoC (advice of charge) indicator to Application.

7) Application receives AoC and proceeds to perform event and then generates event confirmed/denied back to Control

8) Mcommerce enabler commits/revokes transaction (s) as required

9) All elements produce CDRs as required for audit, reconciliation, marketing etc purposes.

Generic Duration/Volume Charges Call Flow

This follows the traditional prepaid call flow, but the destination data is required for the granularity of billing. It is necessary that this flow be heavily optimized.

1) Network element (MSC or GGSN) 10 receives request for call or packet to/from destination

2) Network element requests a coupon from database 1 per standard prepaid model in terms of time or volume with destination and source data. A coupon is also referred to as a voucher, reservation, or bucket usually only it terms of currency.

3) Database forwards to rating function to determine amount and account(s) to be charged.

4) Database provides coupon or refers to recharge/credit increase

5) User interaction occurs and on exhaustion of coupon repeats from step 2)

6) On termination of interaction, partially used coupon data is returned to database and refunded to relevant account(s).

Since any interaction with a service is via some connection, the two charging models will occur in parallel. It is important for such activities to be coordinated This is already supported in voice call processing through 800 style functions. We achieve this in the packet domain through use of destination charging rules provisioned in the GGSN. Where charging is related to content or application, rules within the GGSN will be triggered and this will result in different charging rates being applied One such rate will be zero to the subscriber allowing for free interactions with applications. This allows charges for network usage to be suppressed, but for charges to be applied via the event mechanisms e.g. purchase of an electronic good such as an MP3, charges to be applied to the third party e.g. advertiser, or the interactions to be free e.g. access to a recharge application or other customer service function. Additionally, such mechanisms will support sharing of charges e.g. between application provider and subscriber for subsidised browsing, between application provider and operator for revenue sharing/premium rate sites and so forth.

Current pre-paid accounts are the model for this approach and are naturally supported. They have a credit limit of zero. This solution would allow for a soft limit of zero and a hard limit of a small amount to allow for controlled completion of current calvactivity, for an “emergency” use and to generally improve customer relations. The agreement with the customer would announce the soft-limit, but the flexibility to go a bit over would generally improve usability and allow the operator to improve customer relations by being tolerant. Of course the hard limit could be the same as the soft limit to fully mimic today's solution.

Post-paid accounts would have some operator set credit limit, which could change over time or in response to customer request. This is exactly analogous to credit cards today and is necessary for the same reason since we envisage e-commerce transactions being charged to the phone account. In addition to the solution described above, the ability to prepare a bill for the user and also for merchant settlements and general accounting is required. This would come from post-processing the records cut by the account DB and through DCR/IPDR from the network elements to ensure complete alignment between account status and physical bill. Settlement of the account could be handled via an application to charge to the users credit card either interactively or by prior agreement.

By way of example, typical call walkthroughs for browsing, making a purchase and billing for that purchase are summarized below.

Call Walkthrough

User opens the URL to the Music Site

PDP context established in the usual way, PDA allocated IP address, charging ID, and establishes that user is prepaid

MusicSite.com has no match in GGSN filters so GGSN requests coupon for normal rate decrementing the user account

Browsing continues decrementing the normal rate coupon whilst on MusicSite.com

User selects URL to preview the video

Request now matches rule in GGSN filter (URL is sub part of MusicSite.com site) and is at a MusicSite rate

GGSN requests coupon for new rate

MusicSite2 rate is premium rate so coupon has debit to user and credit to MusicSite

Debits made and coupon is provided

Whilst the video plays, traffic still matches the filter and the premium rate coupon is decremented

At the end of the video preview, User asks to be alerted when the Track is available—this is at normal rate so the normal rate coupon is decremented.

The confirmation screen has an ad for the current track for the band in question—since it is free user watches it.

Now it matches the adman rule and a coupon is acquired—however this time the costs are borne by Adman and no decrement to the User account occurs.

User ends the session—so the GGSN refunds the coupons.

The Adman coupon was only a debit to the Adman account so the refund is a credit to the adman account

The MusicStore Coupon was premium rate and transferred funds from User to MusicStore—so to refund User's account is creditted but MusicSite's is decremented.

The Normal rate coupon is the credited to the User account.

Further Call Walkthrough

It is sometime later and the hot new track has hit the streets. In preparation, User's account has been topped up.

MusicStore app now sends an SMS message to the User using NGS notification The next steps are those logically taken and the actual interactions will be optimised for bulk or small transactions particularly in relation to SMS.

NGS validates the Storefront app and passes the request on to Mcommerce

Mcommerce rates the request via WUP—this shows that it is a premium rate SMS and that User should be debited and MusicStore should be credited and Mcommerce. Since the amounts are relatively small and the event is SMS, Mcommerce policy says this can go ahead without user validation. So it executes the transaction and confirms to NGS

NGS uses SMPP to send the SMS and confirms to MusicStore application

User has been waiting for this clicks straightaway

A context is set-up and the URL matches a rule and the relevant coupon is supplied—this time because it is a reduced rate browsing both User and the MusicStore are debited.

User selects track and hits “buy”

Storefront makes Charging request via NGS which validates the storefront and passes the request onto the Mcommerce platform.

Mcommerce gets the event rated (based on the cost passed in by the app) and finds that there would be free minutes due to total Mcommerce spend

The amount is high and for an Mcommerce transaction so Mcommerce has to get user authorisation and payment method selection—but can present the incentive of free minutes plus any other modifications as required. This is done by returning a suitable Wallet URL to User via the storefront

User confirms the spend, and receives a token signed by Mcommerce which is then passed back to the storefront. Note that interaction with Mcommerce could be reduce or zero-rated, but for convenience were assuming it is rated the same as for the Mcommerce site.

Storefront confirms the transaction with Mcommerce via NGS and provides a onetime URL to the FTP site where the MP3 lives.

User initiates the FTP. In this case, the merchant and the operator have agreed a fixed price for the delivery of the track and this was handled as part of the rating I.e credit to MusicStore was less than debit from User. So this is actually a free access URL and no counting/coupon is required.

Whlist the track is downloaded, User browses on the Music storefront at the reduced rate. Whilst IP multiplexes the packets for browsing and download, the GGSN filter ensures that only the chargeable packets cause the coupon to be decremented.

Once all is finished, user shuts down the outstanding coupon balance is refunded and User plays his new MP3 to all his friends.

The following charging scenarios are given by way of illustration and example.

Usage Based Charging:

Uses: browsing(especially public Internet), voice call (either circuit or packet), video call (circuit or packet).

CS voice or video are suited to duration based charging with browsing being more volume based. Browsing could also move to a value based approach with a price per page rather than price per byte. This can be achieved either by zero-rating the transport and requiring the web server to generate the event charge, or through IP sniffing capabilities, which would analyse the HTTP sessions to determine page download and success.

Call Flow: call set-up triggers CDR creation in GGSN. Authentication at network level (i.e. MSISDN based) only. As user browses between sites, the GGSN matches site IP address/URL etc and places costs in the relevant tariff CDR. GGSN interfaces direct to WUP via CTP to perform rating and real-time usage based charges

Event Based Charging:

Uses: For example, purchase of MP3 (desire to incorporate delivery charge into price i.e. zero rate the download but not the selection), find and Guide instance.

Call Flow: The network authenticates the user and GGSN establishes billing per usage based scenarios. The user connects to storefront and browses (packets being charge based on storefront, APN and operator policy). The user selects MP3 track and hits buy. Storefront utilizes charging SCF to request authorization for transaction giving amount. NGS passes to mcommerce which, using business rules, applies operator rating for taxation, mark-up etc. and determines the user payment method. MCommerce then checks credit limits with either the SBI/WUP account or via the payment gateway to the financial institutions based on user preferences, and checks back to user to confirm purchase. If approved, provides confirmation and transaction ID to the storefront, which provides MP3 (one time) URL to client. Client invokes download on URL. URL or server virtual domain/IP address is part of GGSN zero-rate filter. Downloaded packets are collected in the zero-rate bucket and no charge forwarded to the user account. On complete download (or perhaps after one-time URL allocated), the storefront indicates transaction complete to the charging SCF and MCommerce then commits the transaction either to the user's account or directly to the financial institution. Payment occurs when the user and/or merchant account is reconciled through a transfer of funds (for example by charge to credit card).

For Find and Guide, instead of storefront charging for purchased goods, charging potentially occurs for the network based position location request, plus the delivery of the map information from the third party. The map itself could be downloaded free as per the MP3 case with transport charges included in the price per map. Settlement in this instance involves recognition of the split for location request, transport charges and the provision of a map.

Sponsored Charging:

Uses: Free, or credit (to end-user) access to recharge facilities, customer care, 0800 facilities/destination pays, advert download.

Call Flow: call set-up triggers CDR creation in GGSN. Authentication at network level (i.e. MSISDN based) only. User selects customer care. As user browses to free URL, these match the zero/rate filter for their APN and packets are not charged to the users account.

Ideally, usage charges in such will be cross charged to the content provider or sponsor. This is done by the SB/WUP rating engine on request of coupon for usage to the site. In the case of 0800, the rating determines a cost which is applied to the merchants account. Successful debit to the merchant account will result in allocation of a coupon and the browsing proceeds normally. This is identical to the mechanisms used to charge usage to the subscriber, only it is the merchant's account that is charged.

Premium Rate Charging:

Uses: Premium rate or reduced rate: Service fees via sharing of usage based revenue e.g. customer support (especially PCs). competitions, etc

Call Flow: call set-up triggers CDR creation in GGSN. Authentication at network level (i.e. MSISDN based) only. User selects premium site. Destination based charging allows site to match an alternate rate filter. Cost sharing such as some kind of reduced call rate, would result in rating engine determining two (or more) transactions to the relevant co-funders (e.g. subscriber and content provider) all of which must succeed for the coupon to be allocated. Unused balance refunds are performed via the inverse operation. Premium rate content provided via generating a higher cost to the subscriber and crediting the merchant account on allocation of a coupon. Unused balance results in refund to the subscriber and debit to the content provider. Some forms of taxation may be addressed via a similar mechanism if required.

Value Based Charging:

Uses: charge differently for VoIP/Video Streaming for other packet services to ensure competitive voice offer, real-time stock quotes, goal flashes, etc.

Call flow: Similar to event based charging (e.g. per goal flash or stock quote), application can generate charging request via charging SCF.

It will be understood that the above description of a preferred embodiment is given by way of example only and that various modifications may be made by those skilled in the art without departing from the spirit and scope of the invention. It will further be understood that, although the apparatus and method have been described above with particular reference to a wireless network, they are in no way limited to wireless applications and are equally applicable to other network architectures.

1. A method of billing a communications network user for goods or services associated with the transport of packet traffic from that communications network into a packet communications network, each packet having an address, wherein the method comprises; providing a set of rules, and determining from said rules and each packet address, a respective billing tariff and account for that packet.

2. A method as claimed in claim 1, wherein account details for network users and providers of goods and services are stored in a common accounts database.

3. A method as claimed in claim 2, wherein transfers of credit between accounts stored in the accounts database are determined from coupons generated for each transaction.

4. A method as claimed in claim 3, wherein network users have prepaid and postpaid accounts.

5. A method as claimed in claim 4, wherein each user account is accorded a respective credit limit.

6. A method as claimed in claim 5, wherein a user validation is performed prior to completion of a transaction.

7. A method as claimed in claim 6 wherein the network is a wireless network

8. A method of on-line shopping in which the cost of goods or services purchased by a customer are debited to that customer's pre-paid or postpaid account with a network operator, and a corresponding credit is applied to an account held by the provider of those goods or services.

9. A method as claimed in claim 8, wherein a transaction charge is retained by the operator.

10. A method as claimed in claim 9, wherein a supplier of goods or services is credited with a portion of the network operator's revenue for the transport of packet traffic relating to a transaction.

11. A method of providing combined billing of a communications packet network user for the delivery of communications services to that user and for the on-line purchase of goods and services by the user via the communications network, wherein the method comprises; providing a set of rules, and determining from said rules and each packet address, a respective billing tariff and account for that packet.

12. A method as claimed in claim 11, wherein network users have prepaid and postpaid accounts.

13. A method as claimed in claim 12, wherein each user account is accorded a respective credit limit.

14. A method as claimed in claim 13, wherein a supplier of goods or services is credited with a portion of the network operator's revenue for the transport of packet traffic relating to a transaction

15. A method as claimed in claim 14, wherein said network comprises a wireless network.

16. Software in machine readable form on a storage medium and arranged to perform the method of claim 15.

17. Apparatus for billing a communications network user for goods or services associated with the transport of packet traffic from that communications network into a packet communications network, the apparatus comprising: means for providing each packet with an address, a store having a set of rules, and a packet analyzer for determining from said rules and each packet address, a respective billing tariff and account for that packet.

18. Apparatus as claimed in claim 17, wherein network users have prepaid and postpaid accounts.

19. Apparatus as claimed in claim 18, wherein each user account is accorded a respective credit limit.

20. Apparatus as claimed in claim 19, wherein said network comprises a wireless network.
